(19) United States
(12) Patent Application Publication
(10) Pub. No.: US 2020/0100312 A1
(43) Pub. Date: Mar. 26, 2020

(54) USER DEVICE, RADIO BASE STATION, AND RADIO COMMUNICATION METHOD

(71) Applicant: NTT DOCOMO, INC., Tokyo (JP)

(72) Inventors: Wuri Andarmawanti Hapsari, Tokyo (JP); Hideaki Takahashi, Tokyo (JP)

(73) Assignee: NTT DOCOMO, INC., Tokyo (JP)

(21) Appl. No.: 16/607,625

(22) PCT Filed: Apr. 24, 2017
(86) PCT No.: PCT/JP2017/016248

§ 371 Date: Oct. 23, 2019

(51) Int. Cl. H04W 76/19; H04W 68/00

(52) U.S. Cl. CPC H04W 76/19; H04W 68/00

(57) ABSTRACT

UE (200) receives, in a connected state (RRC_CONNECTED) of RRC layer, a paging message at a predetermined paging cycle. When a paging record addressed to the UE (200) is included in the received paging message, the UE (200) causes the RRC layer to transition from the connected state to an idle state (RRC_IDLE) or an inactive state (RRC_Inactive) and performs with eNB (100) a connection establishment procedure in the RRC layer.

### TECHNICAL FIELD

The present invention relates to a user device, a radio base station, and a radio communication method capable of transmitting and/or receiving a message of a radio resource control layer.

### BACKGROUND ART

3rd Generation Partnership Project (3GPP) specifies Long Term Evolution (LTE), and with the aim of further speeding of the LTE, specifies LTE-Advanced (hereinbelow, the LTE includes the LTE-Advanced). Moreover, in the 3GPP, further, specification of a succeeding system of the LTE called 5G New Radio (NR) and the like is being considered.

In the LTE, momentary degradation in a communication quality in a wireless section between a user device (User Equipment, UE) and a radio base station (eNB) sometimes occurs. When such degradation occurs, a state mismatch may be caused in a radio resource control layer (RRC layer).

As a typical example, when the eNB transmits RRC Connection Release to the UE, and if the momentary degradation of the communication quality in the wireless section occurs, the UE cannot receive the RRC Connection Release. However, because such momentary degradation recovers immediately, this does not lead to detection as a radio link fault (RLF).

Because the eNB that transmitted the RRC Connection Release can transition to an idle state without waiting for a reply from a lower layer (e.g., radio link control layer (RLC)), the eNB transitions to the idle state (RRC_IDLE) even if the UE cannot receive the RRC Connection Release. On the other hand, the UE maintains a connected state (RRC_CONNECTED) as it does not receive the RRC Connection Release. Therefore, a state (RRC_IDLE) of the eNB and a state (RRC_CONNECTED) of the UE in the RRC layer become mismatched.

The UE that is in the RRC_CONNECTED state does not receive a paging message. Therefore, in such a mismatched state, even if the eNB transmits a paging message to the UE, the UE cannot receive the paging message.

In the LTE, to solve such a problem, the following method is prescribed. That is, a common timer (Data Inactivity Timer) is set in both the UE and the eNB, and when the timers expire, the state of the UE and the eNB in the RRC layer is transitioned to the idle state (e.g., see Non-Patent Document 1).

On the other hand, this timer is reset when Dedicated Traffic Channel (DTCH), Dedicated Control Channel (DCCH), or Common Control Channel (CCCH) is transmitted between the UE and the eNB.

### PRIOR ART DOCUMENT

### Non-Patent Document

Non-Patent Document 1: 3GPP TS 36.321 V14.2.0 Subclause 5.17 Data inactivity monitoring, 3rd Generation Partnership Project; Technical Specification Group Radio Access Network; Evolved Universal Terrestrial Radio Access (E-UTRA); Medium Access Control (MAC) protocol specification (Release 14), 3GPP, March 2017

### SUMMARY OF THE INVENTION

However, a time value that needs to be set in the timer can vary depending on provided services, performed applications, and the like. Furthermore, it is also necessary to consider a relation with a timer (UE Inactivity Timer) in the eNB used for transitioning the UE to the idle state.

That is, the setting of the timer (Data Inactivity Timer) is involves operational complexity.

The present invention has been made in view of the above discussion. One object of the present invention is to provide a user device, a radio base station, and a radio communication method capable of preventing, while evading operational complexity, a defect occurring because of a mismatch in the radio resource control layer (RRC layer) due to a momentary degradation in a communication quality in a wireless section.

A user device according to one aspect of the present invention is a user device (UE 200) that transmits and/or receives a message of a radio resource control layer (RRC layer). The user device includes a paging receiving unit (paging receiving unit 220) that receives a paging message at a predetermined paging cycle in a connected state of the radio resource control layer (RRC_CONNECTED); and a connection processing unit (RRC connection processing unit 230) that, when a paging record addressed to the user device is included in the paging message received by the paging receiving unit, causes the radio resource control layer to transition from the connected state to an idle state (RRC_IDLE), and performs a connection establishment procedure in the radio resource control layer with a radio base station.

A radio base station according to another aspect of the present invention is a radio base station (eNB 100) that transmits and/or receives message of a radio resource control layer. The radio base station includes a paging transmitting unit (paging transmitting unit 120) that transmits toward a user device a paging message including a paging record addressed to the user device; and a connection processing unit (RRC connection processing unit 130) that performs a connection establishment procedure in the radio resource control layer with the user device. The paging transmitting unit adds a holding indication (contextResumeInd), which indicates that the radio base station holds setting information (UE context) in the radio resource control layer of the user device, to the paging record addressed to the user device.

A radio communication method according to still another aspect of the present invention is a radio communication method implemented in a radio communication system that transmits and/or receives a message of a radio resource control layer. The radio communication method includes receiving in which a user device receives a paging message at a predetermined paging cycle in a connected state of the radio resource control layer; and transitioning in which the user device, when a paging record addressed to the user device is included in the paging message received by the user device, causes the radio resource control layer to transition from the connected state to an idle state, and the user device performs a connection establishment procedure in the radio resource control layer with a radio base station.

### BRIEF DESCRIPTION OF DRAWINGS

FIG. 1 is an overall structural diagram of a radio communication system 10.

FIG. 2 is a functional block diagram of UE 200.

FIG. 3 is a functional block diagram of eNB 100.

FIG. 4 is a view showing a communication sequence (Operation Example 1) to fix a state mismatch between the eNB 100 and the UE 200 in RRC layer.

FIG. 5 is a view showing another communication sequence (Operation Example 2) to fix a state mismatch between the eNB 100 and the UE 200 in the RRC layer.

FIG. 6 is a view showing a structural example of a paging message (Paging) transmitted from the eNB 100 toward the UE 200.

FIG. 7 is a view showing still another communication sequence (Operation Example 3) to fix a state mismatch between the eNB 100 and the UE 200 in the RRC layer.

FIG. 8 is a view showing an example of hardware configuration of the eNB 100 and the UE 200.

### MODES FOR CARRYING OUT THE INVENTION

Exemplary embodiments are explained below with reference to the accompanying drawings. In the drawings, structural elements having the same or similar functions or same or similar configuration are indicated by the same or similar reference numerals and the explanation thereof is appropriately omitted.

### (1) Overall Structural Configuration of Radio Communication System

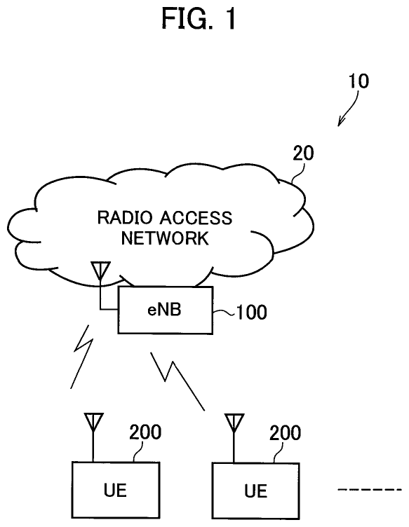

FIG. 1 is an overall structural diagram of a radio communication system 10 according to the present embodiment. The radio communication system 10 is a radio communication system in accordance with Long Term Evolution (LTE). The radio communication system 10 includes a radio access network 20 and a user device 200 (hereinafter, “UE 200”).

The radio access network 20 is Evolved Universal Terrestrial Radio Access Network (E-UTRAN) prescribed in 3GPP, and includes a radio base station 100 (hereinafter, “eNB 100”). Note that, the radio communication system 10 is not necessarily limited to the LTE (E-UTRAN). For example, the radio access network 20 can be a radio access network including a radio base station that performs radio communication with a user device (UE) stipulated as 5G.

The eNB 100 and the UE 200 perform the radio communication in accordance with specification of the LTE or the 5G (hereinafter, “LTE and the like”). Particularly, in the present embodiment, the eNB 100 and the UE 200 transmit and/or receive a message (hereinafter, “RRC message”) of a radio resource control layer (RRC layer).

Specifically, the eNB 100 transmits, toward the UE 200, RRC Connection Reconfiguration, RRC Connection Release, Paging, and RRC Connection Setup, and the like prescribed in 3GPP TS36.331 (RRC Protocol specification).

Moreover, the UE 200 transmits, toward the eNB 100, RRC Connection Reconfiguration Complete, RRC Connection Request, RRC Connection Resume Request, RRC Connection Setup Complete, and the like.

Moreover, the eNB 100 and the UE 200 include, as protocols other than the RRC layer, a physical layer (PHY), a media access control layer (MAC), a radio link control layer (RLC), and Packet Data Convergence Protocol layer (PDCP) in this order from lower layer. The RRC layer is located above the PDCP layer. Furthermore, the eNB 100 and the UE 200 include Non-Access Stratum layer (NAS) as an upper layer of the RRC layer.

### (2) Functional Block Configuration of Radio Communication System

A functional block configuration of a radio communication system 10 is explained below. Specifically, a functional block configuration of the eNB 100 and the UE 200 is explained.

### (2.1) UE 200

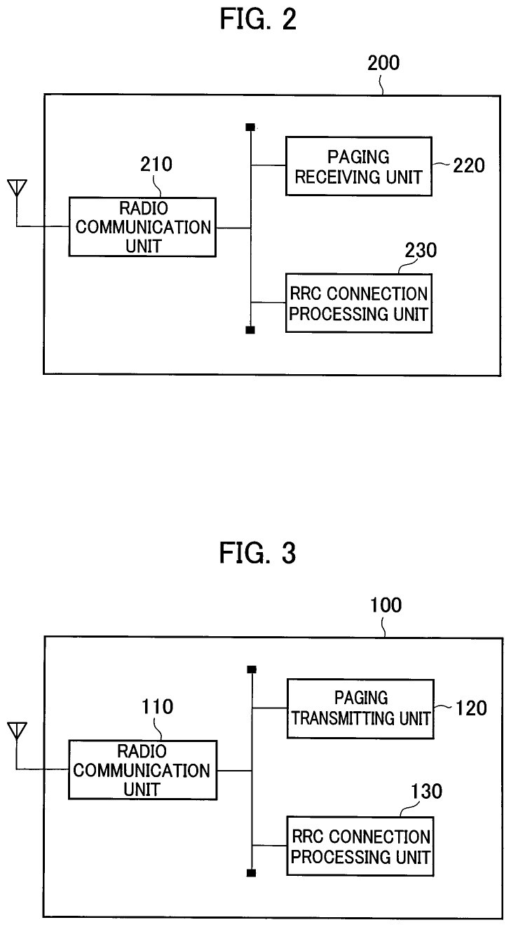

FIG. 2 is a functional block diagram of the UE 200. As shown in FIG. 2, the UE 200 includes a radio communication unit 210, a paging receiving unit 220, and RRC connection processing unit 230.

The radio communication unit 210 performs the radio communication with the eNB 100 in accordance with the LTE and the like. Specifically, the radio communication unit 210 transmits and/or receives radio signals to and/or from the eNB 100 in accordance with the LTE and the like. The RRC message, user data, and the like are multiplexed in the radio signal.

The paging receiving unit 220 receives a paging message transmitted from the radio access network 20, specifically, transmitted from the eNB 100.

More specifically, the paging receiving unit 220 receives the Paging prescribed in Chapter 5.3.2 of the 3GPP TS36.331. Particularly, in the present embodiment, the paging receiving unit 220 receives the Paging, in the connected state (RRC_CONNECTED) of RRC layer, at a predetermined paging cycle.

The paging cycle is specified based on notification information, specifically, by SIB (System Information Block). The paging receiving unit 220 receives the Paging at the transmission cycle (e.g., 320 ms, 640 ms, and the like). That is, the paging receiving unit 220 attempts reception of the Paging at the paging cycle when the UE 200 is in the RRC_CONNECTED state.

Note that, when the paging cycle is specified by the SIB, for the paging cycle, the values explained below can be used in consideration of the actual setting and the like of the RRC layer.

The paging cycle (defaultPagingCycle) for the Paging when in the idle state and notified of in the SIB

The paging cycle (e.g., defaultCONNPagingcycle) that is different from the Paging for the idle state notified of in the SIB

Moreover, the paging receiving unit 220 can also receive the Paging at the predetermined paging cycle even when the UE 200 is in a discontinuous reception state (DRX state). Specifically, the paging receiving unit 220 receives the Paging at the predetermined paging cycle (e.g., 10 sec and the like) in the discontinuous reception state in which the paging receiving unit 220 discontinuously receives the RRC message sent by the eNB 100.

That is, the paging receiving unit 220 attempts reception of the Paging at this cycle while the UE 200 is in the RRC_CONNECTED state and also in the DRX state.

Moreover, the paging receiving unit 220 can receive the Paging in the paging cycle prescribed depending on a type of data radio bearer (DRB) set by the UE 200, or a type of the UE 200. That is, it is possible to set a separate paging cycle for each of the UEs 200 based on an instruction from the radio access network 20.

Specifically, the paging receiving unit 220 attempts reception of the Paging based on the paging cycle set by the radio access network 20. The paging cycle can be determined based on the type of the DRB set by the UE 200. Note that, the type of DRB can be an identifier (QFI) of Quality Of Service (QoS) flow.

Moreover, the type of the UE 200 naturally includes an ordinary UE category. For example, the paging cycle, that is, the cycle at which the UE 200 attempts the Paging, can be set to a different cycle depending on whether the category is a category (specifically Category M1, M2) for MTC (Machine-Type Communications), or a category for NB-IoT (Narrow Band Internet of Things).

The RRC connection processing unit 230 performs a connection processing of a connection in the RRC layer (RRC connection). Specifically, by transmitting and/or receiving the RRC message, the RRC connection processing unit 230 can set or release the RRC connection.

Particularly, in the present embodiment, when a paging record addressed to the UE 200 is included in the Paging received by the paging receiving unit 220, the RRC connection processing unit 230 causes the RRC layer to transition from the connected state (RRC_CONNECTED) to the idle state (RRC_IDLE).

The RRC_CONNECTED is a state prescribed in 3GPP TS36.331 and the like, and it is a state in which the RRC connection has been established between the eNB 100 and the UE 200. On the other hand, RRC_IDLE is a state in which the RRC connection is not established.

In the RRC_CONNECTED, it is possible to transition to the DRX. Moreover, in the RRC_CONNECTED, the Paging is not received except in the above mentioned case and/or in case of supporting ETWS (Earthquake and Tsunami Warning System). On the other hand, in the RRC_IDLE, reception of the Paging is attempted at the paging cycle.

Furthermore, after causing the RRC layer to transition to the RRC_IDLE transition, the RRC connection processing unit 230 performs a connection establishment procedure (RRC Connection Establishment Procedure) in the RRC layer with the eNB 100. Specifically, the RRC connection processing unit 230 transmits, as the RRC Connection Establishment Procedure, the RRC Connection Request to the eNB 100.

Moreover, when the RRC layer of the UE 200 is in a suspend state (suspend state), the RRC connection processing unit 230 can perform, as the RRC Connection Establishment Procedure, the RRC Connection Resume Procedure with the eNB 100. In this case, the RRC connection processing unit 230 transmits, not the RRC Connection Request, but the RRC Connection Resume Request to the eNB 100.

The start of the suspend state of the RRC layer is controlled by the radio access network 20 (E-UTRAN). The RRC connection processing unit 230 holds a context (setting information, UE context) of the UE 200, specifically various setting states in AS (Access Stratum) of the UE 200, and an identifier (resumeIdentity) used for recognizing the suspend state.

In the suspend state of RRC layer, it is considered that the RRC layer is in the idle state (RRC_IDLE) and that the NAS (Non-Access Stratum) layer is in the EMM_CONNECTED (there is indication of the suspend state).

Moreover, the RRC connection processing unit 230 determines whether a holding indication that indicates that the eNB 100 holds setting information in the RRC layer of the UE 200, that is, the above-mentioned context (UE context) of the UE 200, is added to the paging record included in the Paging (paging message) received by the paging receiving unit 220.

The holding indication can be shown with a flag and the like, or can be shown by using a particular integer (number). In the present embodiment, the holding indication is one field among the fields constituting the Paging. In the present embodiment, the holding indication is expressed as “contextResumeInd”.

When the holding indication is included in the paging message, specifically, when the contextResumeInd has been added to the paging record, the RRC connection processing unit 230 causes the RRC layer to transition from the suspend state to the idle state, and performs the RRC Connection Resume Procedure by using the context of the UE 200.

Moreover, when the contextResumeInd has been added to the paging record, the RRC connection processing unit 230 can cause the RRC layer to transition, not to the idle state, but to an inactive state, and perform the RRC Connection Resume Procedure.

The inactive state (Originative) is a state that is different from the connected state (RRC_CONNECTED) and the idle state (RRC_IDLE). Specifically, in the inactive state, the UE is in a state where its power consumption is the same as when it is in the RRC_IDLE. However, in the inactive state, unlike in the RRC_IDLE, the UE context is held in a mobility management entity (MME) of the eNB 100 and a core network.

Note that, in the present embodiment, it is possible to set Data Inactivity Timer (data inactivity timer) in the eNB 100 and the UE 200. The Data Inactivity Timer is a timer for monitoring that transmission and/or reception of signaling and data is not performed for a predetermined time in the connected state (RRC_CONNECTED). The Data Inactivity Timer is prescribed in 3GPP TS36.321 (Release-14).

In this manner, when the Data Inactivity Timer has been set in the UE 200 and the eNB 100 and the Data Inactivity Timer has been started in the UE 200, the RRC connection processing unit 230 can operate as explained below. Specifically, when the Data Inactivity Timer is in the started state, the RRC connection processing unit 230 can stop the Data Inactivity Timer when the paging record addressed to the UE 200 is included in the Paging (paging message) received by the paging receiving unit 220. Note that, stopping the Data Inactivity Timer means stopping the measurement performed by the Data Inactivity Timer that is operating and does not mean starting the Data Inactivity Timer after resetting.

When the Data Inactivity Timer stops, based on the standard of the 3GPP TS, the RRC connection processing unit 230 causes the RRC layer to transition to the idle state (RRC_IDLE).

### (2.2) eNB 100

FIG. 3 is a functional block diagram of the eNB 100. As shown in FIG. 3, the eNB 100 includes a radio communication unit 110, a paging transmitting unit 120, and RRC connection processing unit 130.

The radio communication unit 110 performs the radio communication with the UE 200 in accordance with the LTE and the like. Specifically, the radio communication unit 110 transmits and/or receives radio signals to and/or from the UE 200 in accordance with the LTE and the like. The RRC message, the user data, and the like are multiplexed in the radio signal.

The paging transmitting unit 120 transmits a paging message toward one or more UEs 200. As mentioned earlier, the paging message (Paging) is a type of the RRC message, and it is used to page (call) one or more UEs 200. The paging transmitting unit 120 transmits the Paging at the predetermined paging cycle via Paging Control Channel (PCCH).

Specifically, the paging transmitting unit 120 transmits toward the UE 200 the Paging that includes the paging record addressed to the UE 200. The paging record (PagingRecord) is information element (IE) constituting the paging message. The paging record includes an identifier (ue-Identity) of the UE that is the target of the paging and a domain (cn-Domain) of a paging source.

Furthermore, in the present embodiment, the paging transmitting unit 120 can add to the paging record the holding indication (contextResumeInd) that indicates that the eNB 100 holds the setting information (UE context) in the RRC layer of the UE 200.

Specifically, when the RRC layer of the UE 200 has been caused to be transitioned to the suspend state by the RRC connection processing unit 130, and when the paging transmitting unit 120 holds the context (UE context) of the UE 200, the paging transmitting unit 120 adds the holding indication to the paging record.

The RRC connection processing unit 130 performs a connection processing of a connection in the RRC layer (RRC connection). Specifically, like the RRC connection processing unit 230, by transmitting and/or receiving the RRC message, the RRC connection processing unit 130 can set or release the RRC connection.

More specifically, the RRC connection processing unit 130 performs the connection establishment procedure (RRC Connection Establishment Procedure) in the RRC layer with the UE 200. Moreover, when the RRC layer of the UE 200 is in the suspend state (suspend state), the RRC connection processing unit 130 can perform, as the RRC Connection Establishment Procedure, the RRC Connection Resume Procedure with the UE 200.

### (3) Operation of Radio Communication System

An operation of the radio communication system 10 is explained below. Specifically, when the mismatched state occurs between the UE 200 and the eNB 100 in the RRC layer, an operation for fixing the mismatch is explained below. More specifically, because of the momentary degradation of the communication quality in the wireless section, in the RRC layer when the state of the eNB 100 is the idle state (RRC_IDLE) and the state of the UE 200 is the connected state (RRC_CONNECTED), an operation for fixing the mismatch is explained below.

### (3.1) Operation Example 1

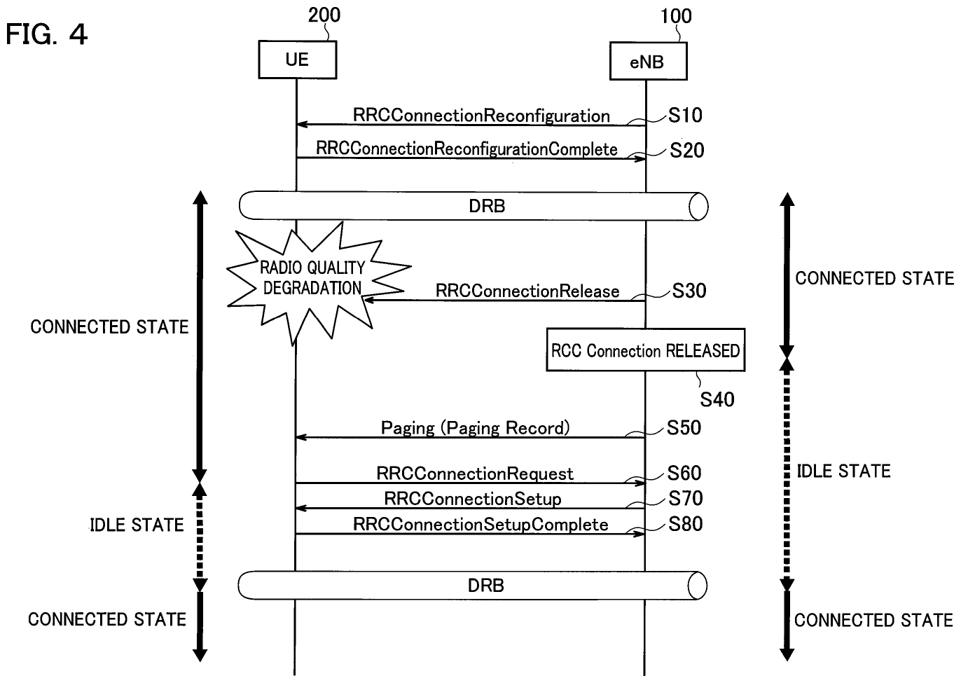

FIG. 4 is a view showing a communication sequence (Operation Example 1) to fix a state mismatch between the eNB 100 and the UE 200 in the RRC layer.

As shown in FIG. 4, for example, the eNB 100 transmits the RRC Connection Reconfiguration to the UE 200 to change the current setting in the RRC layer (Step S10). The UE 200 changes setting in the RRC layer based on the received RRC Connection Reconfiguration, and the UE 200 returns to the eNB 100 the RRC Connection Reconfiguration Complete indicating that the change is completed (Step S20). Accordingly, setting of the data radio bearer (DRB) is maintained. The DRB can be set after the RRC connection has been established.

Thereafter, for example, the eNB 100 determines to release the set RRC connection based on a request from the radio access network 20, and the eNB 100 attempts transmission to the UE 200 of the RRC Connection Release instructing release of the RRC connection (Step S30).

However, here, the momentary degradation of the communication quality in the wireless section occurs whereby the RRC Connection Release does not arrive at the UE 200. That is, the UE 200 cannot receive the RRC Connection Release. However, because the degradation is momentary, this does not lead to detection of a radio link fault (RLF). Therefore, the eNB 100 cannot recognize that the UE 200 cannot receive the RRC Connection Release.

The momentary degradation of the communication quality in the wireless section can occur due to various reasons. For example, the momentary degradation can occur if the UE 200 is momentarily shielded by a shielding object, when there is momentary radio wave interference from an interference source, and the like.

Because the eNB 100 can transition to the idle state (RRC_IDLE) without waiting for a response from the lower layers, the eNB 100 releases the RRC connection (Step S40). As a result, the RRC layer of the eNB 100 transitions (dotted line arrow in FIG. 4) to the idle state. Accordingly, all the related settings (configuration) including the DRB, the signaling radio bearer (SRB), and the like are released.

On the other hand, the UE 200 cannot receive the RRC Connection Release. Accordingly, the RRC layer of the UE 200 is maintained in the connected state (RRC_CONNECTED) (solid arrows in FIG. 4).

Then, the eNB 100 receives the paging request from the radio access network 20 addressed to the UE 200 and transmits the paging message toward the UE 200 (Step S50). Specifically, the eNB 100 transmits the Paging, which is a type of the RRC message, toward the UE 200. As mentioned earlier, the Paging includes the paging record (PagingRecord).

Here, although the UE 200 is in the connected state (RRC_CONNECTED), it receives the Paging. That is, the UE 200 attempts reception of the Paging at the predetermined paging cycle.

When the paging record (specifically, ue-Identity) is included in the received Paging addressed to the UE 200, the UE 200 transitions from the connected state (RRC_CONNECTED) to the idle state (RRC_IDLE) and performs the connection establishment procedure (RRC Connection Establishment Procedure).

Specifically, the UE 200 transmits the RRC Connection Request to the eNB 100 (Step S60). The eNB 100 transmits, based on the received RRC Connection Request, to the UE 200, the RRC Connection Setup including the setting information in RRC layer (Step S70).

The UE 200 performs setting in the RRC layer based on the received RRC Connection Setup, and returns the RRC Connection Setup Complete indicating that the setting having been completed to the eNB 100 (Step S80).

As a result, the DRB is set, and the state mismatch between the eNB 100 and the UE 200 in the RRC layer is also fixed, and both the devices transition to the connected state (RRC_CONNECTED).

### (3.2) Operation Example 2

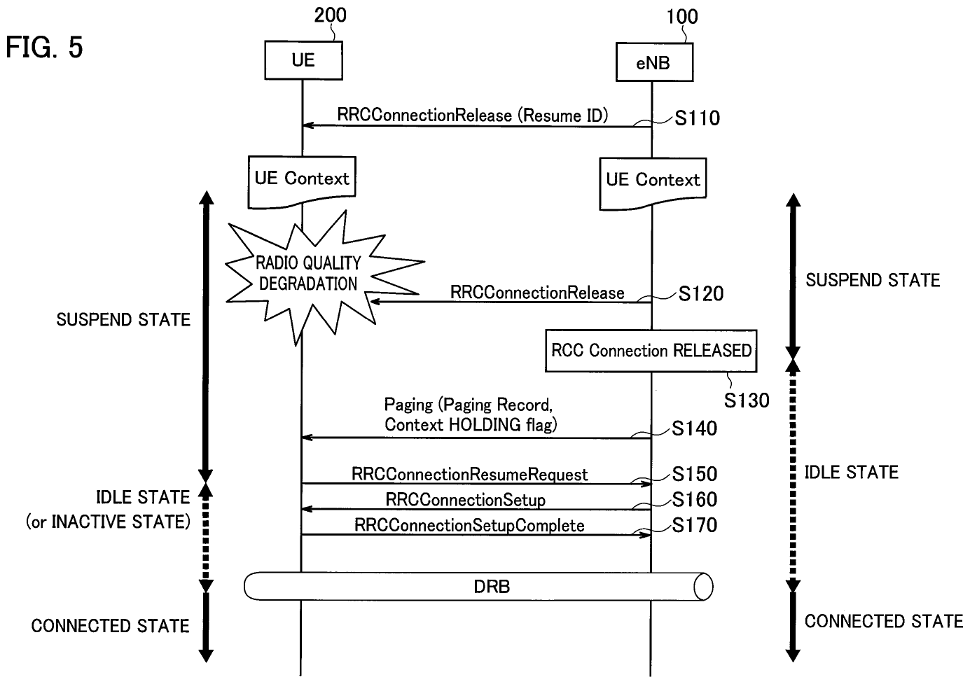

FIG. 5 is a view showing a communication sequence (Operation Example 2) to fix the state mismatch between the eNB 100 and the UE 200 in the RRC layer. In Operation Example 2, a case is explained in which, when the RRC layer is in the suspend state (suspend state), the RRC Connection Release transmitted by the eNB 100 does not arrive at the UE 200. The different portions with respect to Operation Example 1 will be mainly explained here.

As shown in FIG. 5, for example, the eNB 100 determines to suspend the set RRC connection based on a request from the radio access network 20, and the eNB 100 transmits to the UE 200 the RRC Connection Release instructing release of the RRC connection (Step S110).

The RRC Connection Release includes the identifier (Resume ID) indicating the suspend state. In the suspend state of the RRC layer, the context (UE context) of the UE 200 is held in the eNB 100 and the UE 200.

Then, for example, the eNB 100 determines to release the set RRC connection based on a request from the radio access network 20, and the eNB 100 attempts sending to the UE 200 of the RRC Connection Release instructing release of the RRC connection (Step S120).

However, like in Operation Example 1, the momentary degradation of the communication quality in the wireless section occurs whereby the RRC Connection Release does not arrive at the UE 200.

Because the eNB 100 can transition to the idle state (RRC_IDLE) or the inactive state (RRC_Inactive) without waiting for a response from the lower layers, the eNB 100 releases the RRC connection (Step S130). As a result, the RRC layer of the eNB 100 transitions (dotted line arrow in FIG. 4) to the idle state.

On the other hand, the UE 200 cannot receive the RRC Connection Release. Accordingly, the RRC layer of the UE 200 is maintained in the connected state (RRC_CONNECTED) (solid arrows in FIG. 4).

Then, the eNB 100 receives the paging request from the radio access network 20 addressed to the UE 200 and transmits the paging message toward the UE 200 (Step S140). This operation is similar to that in Operation Example 1; however, in the present operation example, the contents of the paging message are different.

Specifically, because the eNB 100 holds the UE context, the eNB 100 generates the paging record containing the holding indication that indicates that the eNB 100 holds the UE context. In the present example, a holding flag indicating that the eNB 100 holds the UE context is added to the paging record.

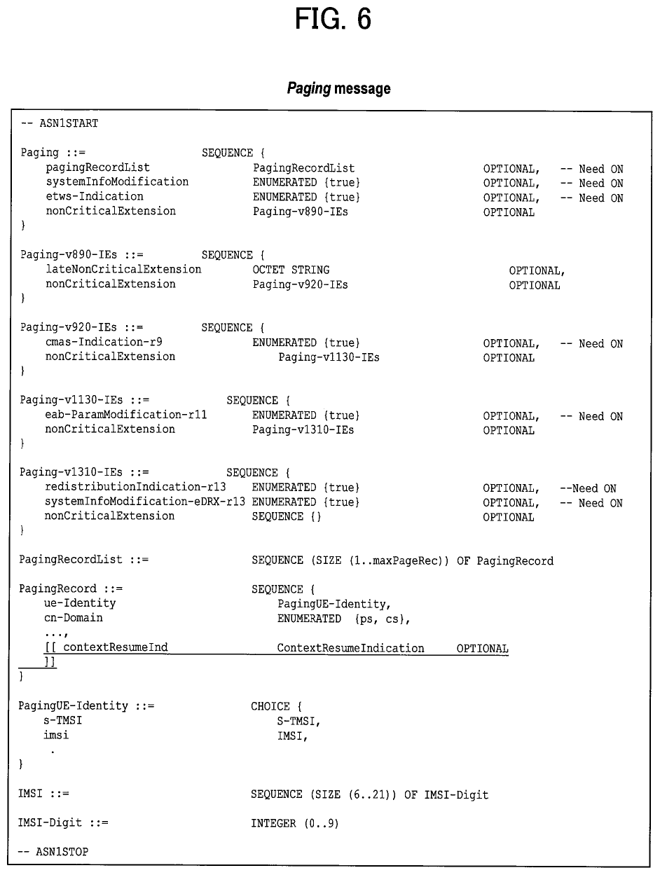

A more concrete example of the holding indication is explained below. FIG. 6 is a view showing a structural example of a paging message (Paging) transmitted from the eNB 100 toward the UE 200. As shown in FIG. 6, the Paging includes the paging record (PagingRecord).

Moreover, as a field of the paging record, the contextResumeInd is provided. The contextResumeInd is a type of the holding indication. In the example shown in FIG. 6, the contextResumeInd functions as a flag indicating holding or not holding of the UE context.

When the holding indication is included in the received Paging, specifically, when the contextResumeInd has been added to the paging record, the UE 200 causes the RRC layer to transition to the idle state (RRC_IDLE), and the UE 200 performs the connection establishment procedure by using the held UE context, specifically, performs the RRC Connection Resume Procedure. Note that, as mentioned earlier, the UE 200 can cause the RRC layer to transition to, not the idle state, but the inactive state.

More specifically, the UE 200 transmits the RRC Connection Request to the eNB 100 (Step S150).

The processing at Steps S160 and S170 are similar to the processing at Steps S70 and S80 of Operation Example 1. However, even here, the held UE context is used.

As a result, the DRB is set, and the state mismatch between the eNB 100 and the UE 200 in the RRC layer is also fixed, and both the devices transition to the connected state (RRC_CONNECTED).

### (3.3) Operation Example 3

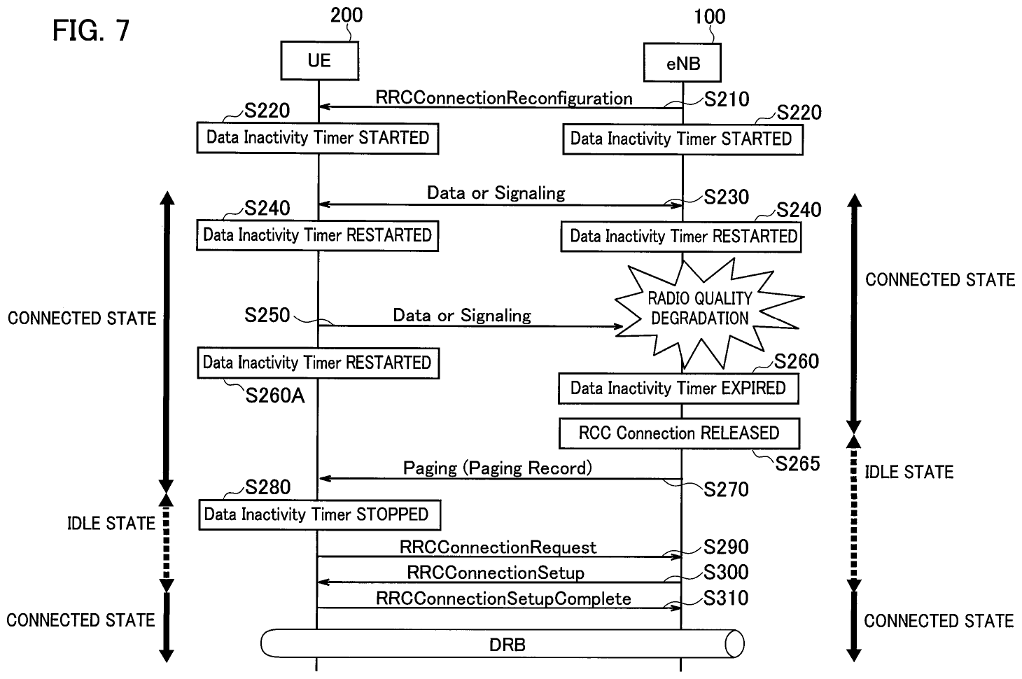

FIG. 7 is a view showing a communication sequence (Operation Example 3) to fix the state mismatch between the eNB 100 and the UE 200 in the RRC layer. In Operation Example 3, the communication sequence to fix the state mismatch between the eNB 100 and the UE 200 when the Data Inactivity Timer (data inactivity timer) prescribed in 3GPP TS36.321 (Release-14) is in operation is explained below. The different portions with respect to Operation Example 1 will be mainly explained here.

As shown in FIG. 7, the eNB 100 transmits a particular RRC message to the UE 200 to set the Data Inactivity Timer (Step S210). Specifically, the eNB 100 sets Data Inactivity Timer by transmitting the RRC Connection Setup or the RRC Connection Reconfiguration. In this example, it is assumed that the RRC Connection Reconfiguration is transmitted.

The eNB 100 and the UE 200 that received and the RRC message sets the Data Inactivity Timer and start the Data Inactivity Timer (Step S220). Specifically, the eNB 100 and the UE 200 set the Data Inactivity Timer based on the setting contents included in the RRC message and start the Data Inactivity Timer.

When transmission and/or reception of the data or the signaling is performed before the Data Inactivity Timer expires, the eNB 100 and the UE 200 restart the Data Inactivity Timer (Steps S230 and S240). That is, the eNB 100 and the UE 200 reset the Data Inactivity Timer and start the timer again. Note that, transmission and/or reception of the data or the signaling is the reception of DTCH, DCCH, or CCCH by the UE 200, or transmission of DTCH or DCCH by the UE 200.

Then, the UE 200 attempts transmission of the data or the signaling; however, the momentary degradation of the communication quality in the wireless section occurs whereby the data or the signaling does not arrive at the UE 200. Therefore, the eNB 100 does not transmit and/or receive the data or the signaling for a predetermined time, and the Data Inactivity Timer of the eNB 100 expires (Step S260). On the other hand, the UE 200 restarts the Data Inactivity Timer (S260A).

In a normal state, that is, when there is no momentary degradation of the communication quality in the wireless section, because the transmission and/or reception of one of the data and the signaling is performed, the Data Inactivity Timer does not expire. In this manner, when the momentary degradation of the communication quality in the wireless section occurs, the Data Inactivity Timer may expire.

Then, because the Data Inactivity Timer has expired, the eNB 100 releases the RRC connection and transitions to the idle state (RRC_IDLE) (Step S265).

On the other hand, because the Data Inactivity Timer does not expire, the UE 200 maintains the connected state (RRC_CONNECTED). As a result, the state mismatch occurs between the eNB 100 and the UE 200.

The eNB 100 receives the paging request from the radio access network 20 addressed to the UE 200 and transmits the Paging toward the UE 200 (Step S270).

When the UE 200 receives the Paging addressed to the UE 200 while the Data Inactivity Timer is operating, the Data Inactivity Timer is stopped (Step S280). When the Data Inactivity Timer is stopped, the UE 200 transitions to the idle state (RRC_IDLE). Such operating is prescribed in Release-14 of the LTE.

The subsequent communication sequence is almost similar to that in Operation Example 1 and Operation Example 2. That is, the UE 200 performs the connection establishment procedure (RRC Connection Establishment Procedure) (Steps S290 to S310).

### (4) Effects and Advantages

With the present embodiment, the following effects and advantages can be obtained. Specifically, even if the UE 200 is in the RRC_CONNECTED state, the UE 200 can attempt the reception of the Paging at the predetermined paging cycle. That is, the Paging can be received if the paging record addressed to the UE 200 is included.

Furthermore, when the paging record addressed to the UE 200 and received in the RRC_CONNECTED is included, the UE 200 can be transitioned from the RRC_CONNECTED to the RRC_IDLE state and can perform the RRC Connection Establishment Procedure.

For the time being assuming that, because of the momentary degradation of the communication quality in the wireless section, even if the “state mismatch” occurs in which the eNB 100 manages the UE 200 and the RRC layer as the RRC_IDLE and the UE 200 manages own RRC layer as the RRC_CONNECTED, the UE 200 can quickly transition to the RRC_IDLE by reception of the Paging. Furthermore, the UE 200 can perform the RRC Connection Establishment Procedure.

Accordingly, any defect occurring because of a mismatch in the RRC layer due to the momentary degradation in the communication quality in the wireless section can be prevented. Specifically, a state that the communication can be started because the UE 200 cannot receive the Paging can be prevented.

Moreover, in the radio communication system 10, even if the state mismatch occurs, because the UE 200 autonomously transitions to the RRC_IDLE state and finally matches with the state in the RRC layer of the eNB 100, one is freed from the operational agony such as setting of the timer value.

In the present embodiment, when the holding indication (contextResumeInd) has been added to the paging record, the eNB 100 and the UE 200 can perform the RRC Connection Resume Procedure by using the held UE context (setting information).

Therefore, when the RRC layer is in the suspend state, quick resetting of the RRC connection that uses the held UE context is enabled. This is because, in the RRC Connection Resume Procedure, transmission and reception of the RRC Connection Reconfiguration, the Initial UE message, and the like, like the RRC Connection Establishment Procedure is unnecessary.

In the present embodiment, the UE 200 can receive the Paging at the predetermined paging cycle even when the UE 200 is in the discontinuous reception state (DRX state). Therefore, even when it is the RRC_CONNECTED but also in the DRX state, the Paging can be received surely, and early fixing of the state mismatch can be achieved.

In the present embodiment, the UE 200 can receive the Paging at the predetermined paging cycle prescribed depending on the type of the data radio bearer (DRB) set by the UE 200 or the type of the UE 200 (UE category). Therefore, the UE 200 can attempt reception of the Paging in an appropriate cycle depending on the state and the type of the UE 200. Thereby, reduction in the battery saving and the processing load of the UE 200 can be achieved.

Particularly, the present invention is effective for the UE used in a scenario of non-moving IoT and where the Paging cycle is relatively short.

In the present embodiment, in the state in which the Data Inactivity Timer is operating in the UE 200, and when the paging record addressed to the UE 200 is included in the received Paging, the UE 200 can stop the Data Inactivity Timer. Therefore, even if the state mismatch occurs between the eNB 100 and the UE 200 because of the momentary degradation in the communication quality in the wireless section while the Data Inactivity Timer is operating, the UE 200 transitions to the idle state (RRC_IDLE) as the Data Inactivity Timer stops. Thereby, early fixing of the state mismatch can be achieved.

### (5) Other Embodiments

The present invention has been explained in detail by using the above mentioned embodiments; however, it is self-evident to a person skilled in the art that the present invention is not limited to the embodiments explained herein and that the embodiments can be modified or improved in various ways.

For example, the above embodiment is explained by using the eNB 100 (radio base station) and the UE 200 (the user device) in accordance with specification of the LTE or the 5G; however, it is fine even if the radio base station and the user device are in accordance with specification of only the 5G.

Moreover, the above embodiment relates to an example of using the message (RRC message) of the radio resource control layer (RRC layer); however, as far as the layer belongs to AS layer and substantially performs control of the radio resource, the layer is not limited to the RRC layer.

Moreover, the block diagrams used for explaining the embodiments (FIGS. 2 and 3) show functional blocks. Those functional blocks (structural components) can be realized by a desired combination of hardware and/or software. Means for realizing each functional block is not particularly limited. That is, each functional block may be realized by one device combined physically and/or logically. Alternatively, two or more devices separated physically and/or logically may be directly and/or indirectly connected (for example, wired and/or wireless) to each other, and each functional block may be realized by these plural devices.

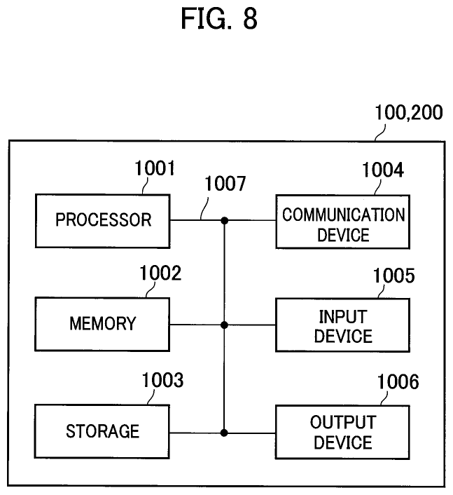

Furthermore, the eNB 100 and the UE 200 explained above can function as a computer that performs the processing of the present invention. FIG. 8 is a diagram showing an example of a hardware configuration of the eNB 100 and the UE 200. As shown in FIG. 8, each of these devices can be configured as a computer device including a processor 1001, a memory 1002, a storage 1003, a communication device 1004, an input device 1005, an output device 1006, a bus 1007, and the like.

The functional blocks of the eNB 100 and the UE 200 (see FIGS. 2 and 3) can be realized by any of hardware elements of the computer device or a desired combination of the hardware elements.

The processor 1001, for example, operates an operating system to control the entire computer. The processor 1001 can be configured with a central processing unit (CPU) including an interface with a peripheral device, a control device, a computing device, a register, and the like.

The memory 1002 is a computer readable recording medium and is configured, for example, with at least one of ROM (Read Only Memory), EPROM (Erasable Programmable ROM), EEPROM (Electrically Erasable Programmable ROM), RAM (Random Access Memory), and the like. The memory 1002 can be called register, cache, main memory (main memory), and the like. The memory 1002 can store therein a computer program (computer program codes), software modules, and the like that can execute the method according to the above embodiments.

The storage 1003 is a computer readable recording medium. Examples of the storage 1003 include an optical disk such as CD-ROM (Compact Disc ROM), a hard disk drive, a flexible disk, a magneto-optical disk (for example, a compact disk, a digital versatile disk, a Blu-ray (Registered Trademark) disk), a smart card, a flash memory (for example, a card, a stick, a key drive), a Floppy (Registered Trademark) disk, a magnetic strip, and the like. The storage 1003 can be called an auxiliary storage device. The recording medium can be, for example, a database including the memory 1002 and/or the storage 1003, a server, or other appropriate medium.

The communication device 1004 is hardware (transmission/reception device) capable of performing communication between computers via a wired and/or wireless network. The communication device 1004 is also called, for example, a network device, a network controller, a network card, a communication module, and the like.

The input device 1005 is an input device (for example, a keyboard, a mouse, a microphone, a switch, a button, a sensor, and the like) that accepts input from the outside. The output device 1006 is an output device (for example, a display, a speaker, an LED lamp, and the like) that outputs data to the outside. Note that, the input device 1005 and the output device 1006 may be integrated (for example, a touch screen).

In addition, the respective devices, such as the processor 1001 and the memory 1002, are connected to each other with the bus 1007 for communicating information there among. The bus 1007 can be constituted by a single bus or can be constituted by separate buses between the devices.

In addition, the manner of notification of information is not limited to the one explained in the embodiments, and the notification may be performed in other manner. For example, the notification of information can be performed by physical layer signaling (for example, DCI (Downlink Control Information), UCI (Uplink Control Information)), upper layer signaling (for example, RRC signaling, MAC (Medium Access Control) signaling, notification information (MIB (Master Information Block), SIB (System Information Block)), other signals, or a combination thereof. In addition, the RRC signaling can be called RRC message, and the RRC signaling can be, for example, RRC Connection Setup message, RRC Connection Reconfiguration message, and the like.

Furthermore, the input/output information can be stored in a specific location (for example, a memory) or can be managed in a management table. The information to be input/output can be overwritten, updated, or added. The information can be deleted after outputting. The inputted information can be transmitted to another device.

The order of the sequences, flowcharts, and the like in the embodiments can be rearranged unless there is a contradiction.

Moreover, in the embodiments explained above, the specific operations performed by the eNB 100 can be performed by another network node (device). Moreover, functions of the eNB 100 can be provided by combining a plurality of other network nodes.

Moreover, the terms used in this specification and/or the terms necessary for understanding the present specification can be replaced with terms having the same or similar meanings. For example, a channel and/or a symbol can be replaced with a signal (signal) if that is stated. Also, the signal can be replaced with a message. Moreover, the terms “system” and “network” can be used interchangeably.

Furthermore, the used parameter and the like can be represented by an absolute value, can be expressed as a relative value from a predetermined value, or can be represented by corresponding other information. For example, the radio resource can be indicated by an index.

The eNB 100 (base station) can accommodate one or more (for example, three) cells (also called sectors). In a configuration in which the base station accommodates a plurality of cells, the entire coverage area of the base station can be divided into a plurality of smaller areas. In each such a smaller area, communication service can be provided by a base station subsystem (for example, a small base station for indoor use RRH: Remote Radio Head).

The term “cell” or “sector” refers to a part or all of the coverage area of a base station and/or a base station subsystem that performs communication service in this coverage. In addition, the terms “base station” “eNB”, “cell”, and “sector” can be used interchangeably in the present specification. The base station can also be referred to as a fixed station, NodeB, eNodeB (eNB), gNodeB (gNB), an access point, a femtocell, a small cell, and the like.

The UE 200 is called by the persons skilled in the art as a subscriber station, a mobile unit, a subscriber unit, a radio unit, a remote unit, a mobile device, a radio device, a radio communication device, a remote device, a mobile subscriber station, an access terminal, a mobile terminal, a radio terminal, a remote terminal, a handset, a user agent, a mobile client, a client, or with some other suitable term.

As used herein, the phrase “based on” does not mean “based only on” unless explicitly stated otherwise. In other words, the phrase “based on” means both “based only on” and “based at least on”.

Furthermore, the terms “including”, “comprising”, and variants thereof are intended to be inclusive in a manner similar to “having”. Furthermore, the term “or” used in the specification or claims is intended not to be an exclusive disjunction.

Any reference to an element using a designation such as “first”, “second”, and the like used in the present specification generally does not limit the amount or order of those elements. Such designations can be used in the present specification as a convenient way to distinguish between two or more elements. Thus, the reference to the first and second elements does not imply that only two elements can be adopted, or that the first element must precede the second element in some or the other manner.

Throughout the present specification, for example, during translation, if articles such as a, an, and the in English are added, these articles shall include plurality, unless it is clearly indicated that it is not so according to the context.

As described above, the details of the present invention have been disclosed by using the embodiments of the present invention. However, the description and drawings which constitute part of this disclosure should not be interpreted so as to limit the present invention. From this disclosure, various alternative embodiments, examples, and operation techniques will be apparent to a person skilled in the art.

### INDUSTRIAL APPLICABILITY

As mentioned earlier, the present invention is useful in, while evading operational complexity, preventing occurrence of the defect because of the state mismatch in the radio resource control layer (RRC layer) due to the momentary degradation in the communication quality in the wireless section.

### EXPLANATION OF REFERENCE NUMERALS

10 radio communication system
20 radio access network
100 eNB
110 radio communication unit
120 paging transmitting unit
130 RRC connection processing unit
200 UE
210 radio communication unit
220 paging receiving unit
230 RRC connection processing unit

1. A user device that transmits and/or receives a message of a radio resource control layer, comprising:
a paging receiving unit that receives a paging message at a predetermined paging cycle in a connected state of the radio resource control layer; and
a connection processing unit that, when a paging record addressed to the user device is included in the paging message received by the paging receiving unit, causes the radio resource control layer to transition from the connected state to an idle state, and performs a connection establishment procedure in the radio resource control layer with a radio base station.

2. The user device as claimed in claim 1, wherein, when a holding indication that indicates that the radio base station holds setting information in the radio resource control layer of the user device has been added to the paging record included in the paging message,
the connection processing unit causes the radio resource control layer to transition to the idle state or an inactive state and performs the connection establishment procedure by using the setting information.

3. The user device as claimed in claim 1, wherein the paging receiving unit receives the paging message at the predetermined paging cycle in a discontinuous reception state in which the message transmitted from the radio base station is received in a discontinuous manner.

4. The user device as claimed in claim 1, wherein the paging receiving unit receives the paging message at the predetermined paging cycle prescribed depending on a type of a data radio bearer set by the user device or a type of the user device.

5. The user device as claimed in claim 1, wherein
a data inactivity timer that monitors in the connected state whether data is not transmitted and/or received for predetermined time is set in the user device and the radio base station, and
the connection processing unit, while the data inactivity timer in the user device is in a started state, if the paging record addressed to the user device is included in the paging message received by the paging receiving unit, stops the data inactivity timer.

6. A radio base station that transmits and/or receives a message of a radio resource control layer, comprising:
a paging transmitting unit that transmits toward a user device a paging message including a paging record addressed to the user device; and
a connection processing unit that performs a connection establishment procedure in the radio resource control layer with the user device, wherein
the paging transmitting unit adds a holding indication, which indicates that the radio base station holds setting information in the radio resource control layer of the user device, to the paging record addressed to the user device.

7. A radio communication method implemented in a radio communication system that transmits and/or receives a message of a radio resource control layer, comprising:
receiving in which a user device receives a paging message at a predetermined paging cycle in a connected state of the radio resource control layer; and
transitioning in which the user device, when a paging record addressed to the user device is included in the paging message received by the user device, causes the radio resource control layer to transition from the connected state to an idle state, and the user device performs a connection establishment procedure in the radio resource control layer with a radio base station.
